(19) United States
(12) Patent Application Publication
(10) Pub. No.: US 2013/0344227 A1
(43) Pub. Date: Dec. 26, 2013

(54) DAIRY BASED SHELF LIFE EMULSION

(71) Applicant: John Jason Scott Quigley, Bedford (CA)

(72) Inventor: John Jason Scott Quigley, Bedford (CA)

(73) Assignee: MURDOCH - ADVANCING FOOD SCIENCE AND SAFETY INC., Halifax, NS (CA)

(21) Appl. No.: 14/003,975

(22) PCT Filed: Mar. 6, 2012
(86) PCT No.: PCT/CA2012/050133

§ 371 Date: Sep. 9, 2013

Related U.S. Application Data
(60) Provisional application No. 61/450,447, filed on Mar. 8, 2011.

(51) Int. Cl. A23L 1/48

(52) U.S. Cl. CPC A23L 1/483
USPC 426/605

(57) ABSTRACT

The present invention is directed to advancing food safety with a food shelf-life extending emulsification matrix, a method for making such oil-in-water emulsification matrix by high shear homogenization with added acid, dairy products, egg-whites, starches, gums and preservatives. The emulsification matrix thus created can be used as substitute for mayonnaise, or sauces, dips, dressings, and applied as a food shelf-life extender to food suitable for coating by an emulsion mixture. Preferably the coating is prepared and applied under an inert gas blanket, from a class of edible, inert gases, including nitrogen or argon. This food shelf-life extending emulsification matrix can be applied to any form of prepared protein including meats, fish/seafood, poultry, eggs, as well as fruits, vegetables, or home-meal-replacement (HMR) applications and other ready-to-eat (RTE) chilled prepared food products; including those stored in a refrigerated; or alternatively, frozen environment subsequently slacked-out/thawed.

This application claims priority to U.S. Provisional Application No. 61/450,447 filed Mar. 8, 2011, the contents of which are hereby incorporated by reference in their entirety.

### FIELD OF THE INVENTION

The present invention relates to a new food product and to a product for treating food and for enhancing food safety by extending shelf-life, the method of manufacture of the class of products and a method of treating food using the product for the purposes of extending shelf-life.

### BACKGROUND

Food safety is an imperative in the pre-packaged foods market. Pre-packaged foods are a multi-billion dollar world-wide industry; and ready to eat (RTE) chilled prepared foods represent a sizable portion of that market. One of the primary obstacles to offering certain foods in a pre-packaged, RTE, format is limited shelf-life.

Shelf-life is a key factor in determining food safety and for developing food products. Longer shelf-life means larger ranges of shipping and larger markets. Shelf-life also leads to consumer satisfaction and safety. Government regulations may also stipulate minimum shelf-life labelling requirements.

A variety of existing techniques have been developed for the preservation of food, including wrapping in plastic, embedded preservatives, sterilization of packaging and food prior to wrapping, and food coatings.

However, in the case of certain foods which readily undergo natural, aerobic, decomposition (like fish/seafood, eggs, meat and poultry) shelf-life is generally considered to be limited as compared to other ready-to-eat products.

Natural foods which include dairy are part of a healthy diet, and are generally recommended by national food guides, but in its natural state, is also subject to short shelf-life.

There is also a desire to achieve freeze thaw stability of dairy based emulsions to permit long term storage and use. Emulsions which lack freeze thaw stability lose their homogeneous structure rendering them visually unpalatable to consumers.

There is a desire in the market for novel dairy based food products for use in spreads and dips.

There is a desire for an edible, shelf-life extending product for the preservation of foods which may be coated, placed in chilled prepared format.

There is a desire for an edible coating which preserves food shelf-life, so as to permit a wider variety of products to be offered in pre-packaged form.

There is a desire for a food preservative which would permit proteins to be used more reliably in chilled prepared state, including proteins such as poultry, meat, seafood, including as a pre-packaged dip.

### SUMMARY

The present inventions are a food composition, a food shelf-life extending emulsion, a method of manufacture for the food (whether or not used as a shelf-life extending emulsion) and a means of application of the food shelf-life extending emulsion to preserve food. Another goal of the present inventions is to advance food science and safety using stabilized dairy-based emulsions developed to prolong product shelf life. The food composition is an an emulsification matrix of an oil in water emulsion further comprising stabilizing emulsifiers such as dairy fats and proteins, gums and fibers having an average micelle diameter predominantly between 3 microns and 40 microns, and having an median micelle between 2 and 5 microns, and average (by volume) of between 5 microns and 20 microns; and having total saturated and unsaturated fat content ranges of 10-50%, water content from 10-80% of the total weight, viscosity range of 15,000-120000 centipoise. The acidity in the product is adjusted during manufacture to between approximately 2.8 pH and 5.5 pH. High shear during the mixing process results in a stable emulsion with very small particle size. Food coated with the matrix has been shown to have extended shelf-life.

Based on testing, the composition achieves extended shelf-life over other products in the market formed of similar ingredients. It is hypothesized, that the enhanced shelf-life is achieved in at least one of five of the following possible ways: 1. intrinsic nature of the matrix, the micrometer level micelle size, and complementary added proteins have a hydrophilic/hydrophobic interaction on the molecular level which appears to extend the shelf-life of the added proteins beyond typical ranges; 2. at the micrometer level, gas bubbles at the food surface are minimized and little to no oxygen is available for aerobic decomposition; 3. naturally occurring anti-microbials in the oils and matured dairy products are more effectively dispersed throughout the emulsion; and 4. the pH of the emulsion is modified during the manufacturing process to a controlled pH level, which may further extend shelf-life; and 5. A nitrogen or argon blanket is optionally applied during processing to further assist in reducing oxygen content within the matrix and on the food.

In one aspect, the composition of the present invention is a novel high shear emulsification matrix comprising water, edible oils, modified starch, xanthan gum, egg whites and fat. The fats may be dairy products. The dairy products may be chosen from a set of dairy products including, cheeses, sour cream, cream cheese, cream, butter, yogurt and others.

In another aspect, the invention is the use of the composition described herein for coating proteins for the purposes of extending shelf life of food products including the coated proteins.

In another aspect, the invention is the use of a form of the composition described herein as a mayonnaise substitute.

In another aspect, the invention is the use of a form of the composition described herein as a dressing.

In another aspect, the invention is the use of a form of the composition described herein as the base matrix for a flavoured dip, or other food stuff normally using a cream cheese or whipped cream cheese base.

In another aspect, the invention is a method of manufacturing the composition. The composition end product can be described as a high shear, dairy based emulsification matrix manufactured according to the following steps.

First, the original emulsions of selected creams, butters and cheeses are broken down during a high shear homogenizing step and then re-emulsified with the other ingredients added at this stage. Here, the dairy components are mixed together with oils and waters for 3 to 5 minutes. The input products may be heated during this step. Standard mixing speed or shear in this stage is possible, but high shear—1800 to 5000 rpm—may also be employed for convenience.

Second, the salts and acids are added and mixed therein for 2 minutes. Again, either standard mixing speeds or high shear speeds may be employed, and the mixture may be heated from ambient temperature.

Third, the gums and starches are added to the composition and mixed at high shear for 3-5 minutes at a temperature of between 50 degrees Celcius and 100 degrees Celsius, into a stabilizing matrix.

Fourth, after the stabilizing matrix is created, egg whites are added and the composition mixed or stirred for 2 to 5 minutes at approximately 50 degrees Celsius to 100 degrees Celsius at mixing speeds of under 1800 rpm. Other proteins may be added in this step, being coated by the mixture.

Temperature during processing typically ranges from 4 degrees Celsius to 70 degrees Celsius in steps 1 and 2, step 3 may be at approximately 70 degrees Celsius, and step 4 at approximately 80 degrees Celsius, Emulsion stability is directly related to shear force and corresponding decreasing diameter of the micelles of the particles of the resulting composition. Shear speeds of 1800 to 5000 rpm are required during the step in which the gums and starches are added. Shear speeds of 1800 to 5000 rpm may be employed during the earlier processing stages for convenience, but are not recommended during the additional of egg whites and optional proteins.

The process of the present invention homogenizes and recombines existing emulsions into a novel, more stable emulsion with supporting matrix with micelles in a 1-20 micron range that has the advantage of being able to protect larger food particles from decomposition, and in particular aerobic decomposition. Particle size ranges predominantly less than 6 microns (averaging about 7.7 microns by volume) and predominantly on the order of 2 to 5 microns have been shown to be achieved using the production method described.

Advantageously, the emulsified matrix of the present invention is adaptable in terms of viscosity; texture and mouth feel by varying the core ingredients and shearing rates. Having a broad range of physical adaptation means it could be potentially used in multiple food categories.

The macro encapsulation process of the present invention is stable following freeze thaw, and is anticipated to provide shelf-life extension to any of the following categories; however it has only been demonstrated for seafood. Any modifications required to adapt the invention to any of the following categories should not limit the disclosures in respect of those categories for which the invention operates as claimed: (a) fruits and vegetables: fresh/frozen and/or preserved in any form; (b) entire frozen food category: whether raw/prepared and/or ready to serve, etc.; (c) meat/poultry/fish/seafood of any kind, and-or form: raw-fresh and/or cured/or partially and/or fully cooked as is; or alternatively as ingredient such as protein based salads; sandwich fillings; “pies” etc.; (d) all “Deli” category and related products whether (home meal replacement—HMR) prepared meals (uncooked or cooked) and/or salads/pizza/etc.; bakery based products: bread/cookies/cakes, etc.; (e) all Dairy/non-dairy based products; including any form of cheese/milk/butter or alternatively-based utilizing soy; (f) pasta and pasta-based products; (g) sandwiches of any kind/hamburger and/or related products; (h) fast food industry whether subs/burgers/tacos/protein and non-protein based products/bakery and/or bakery related/ice cream; dairy and non-dairy based; (i) food service—all categories: protein based/bakery based/soy based/and any form of beverages; and (j) spreads/preserves: of any kind including: peanut butter/jam/marmalades; pickles, etc.

The compositional ingredients include: fat selected from soft or hard fats; vegetable oils which are liquid at ambient room temperature, one or more egg white containing material; one or more edible acids; starches; gums; and water. The fat may be a dairy product, including cheese, cream cheese, sour cream, cream, butter, yogurt, etc. An anti-microbial or other preservative, such as potassium sorbate, edible acids or suitable alternative may also be added within the scope of the present invention, or may be present in the input fats or egg white containing material.

The fat is present at a level of from about 10% to about 50% by weight. Suitable fats may be any food grade fat, including: palm kernel oil; cocoa butter; nut butters; dairy fats including, cheese, sour cream, cream cheese, butter, processed cheese, cream or others.

The vegetable oil may be any of the well recognized food oils, including without limitation as soybean oil, corn oil, cottonseed oil, peanut oil, other nut oils, olive oil, canola oil, sunflower seed oil and other. Vegetable oil should be present at a level preferable less than 10%.

The edible acid, acidifying salt, or fatty acid ester is preferable chosen from the group of edible acids, acidifying salts or fatty acid esters consisting of: acetic acid (vinegar), ascorbic acid (vitamin C), citric acid (lemon juice), and the edible salts and fatty acid esters thereof. These should be added in sufficient quantities to produce the desired taste of the end product at a coating pH of from about 2.8 to about 5.5, to provide for an end food product with a suitable pH level.

The starch can be any smooth, short textured and heavy bodied edible starch, in practice, and testing revealed that modified starch, including without limitation Colflo 67™ and Frigex W™ provided usable product. The starch should be largely unaffected by the desired pH. Starch can be present at a level of from about 0.5% to about 10% by weight, as a thickening agent and to adjust texture.

Added gums, such as xanthan gum, are present in very small amounts (0.01% to 1% by weight), adjust texture.

Optionally, an egg white containing product is present at a level sufficient to provide from about 1% to about 10% egg white protein by weight, to achieve desired rigidity to the composition. As the addition of egg whites, adds volume in the mixing stage, using an inert gas blanket while the egg whites are being mixed provides additional benefit to excluding possible oxygen within the matrix.

Water is present in a quantity sufficient to provide the desired viscosity in the range of 15000-120,000 centipoise, generally achieved with 10-50% of the total weight being water.

High shear is necessary to form micro-particles of the saturated fats and suspended oils to ensure macro encapsulation of food products by an encompassing layer of the inventive coating. Shear speeds of 1800 to 5000 rpm may be employed throughout the processing stages, but are required only in the stage at which gums and starches are added if the other stages are mixed more slowly. These shear speeds can be achieved in appropriate temperature ranges using a Silverson™ or comparable high shear, in-line or other homogenizer.

Certain embodiments of the invention will now be described by way of example only and with reference to the accompanying drawings.

### BRIEF DESCRIPTION

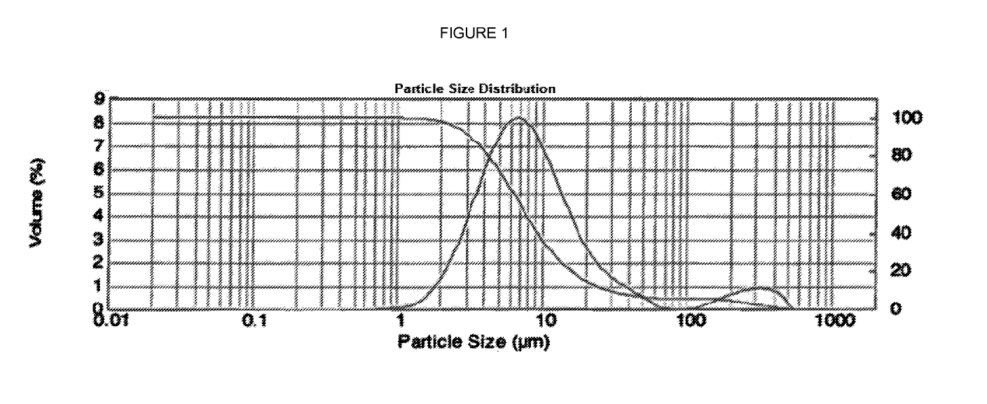

FIG. 1 is a chart showing experimentally determined micelle particle size distributions for a composition of the present invention on a log by percentile scale.

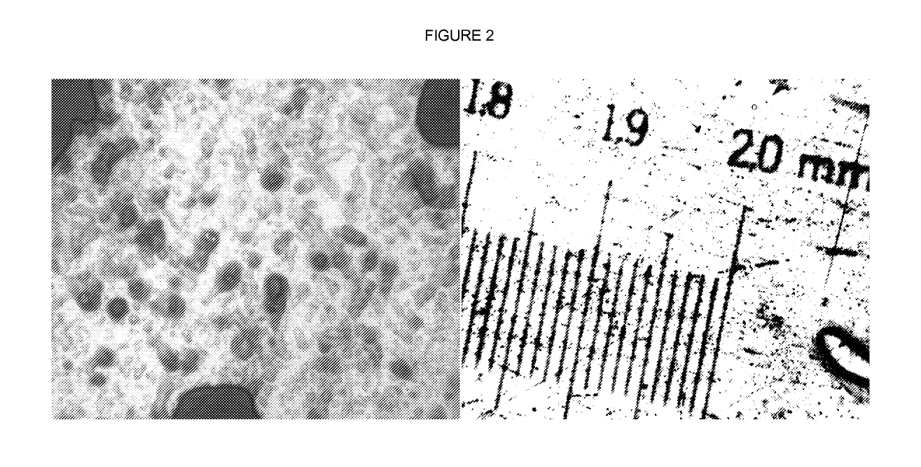

FIG. 2 shows a magnified view of the composition of the emulsification matrix at 20× objective and 350× overall magnification along with a sizing scale which shows that 0.1 mm in the scale of the image representing approximately 10 microns.

### DETAILED DESCRIPTION

In order to demonstrate the physical characteristics of the composition of the present dairy based emulsion, and its shelf life, batches were prepared according to the following method and tested.

The emulsification matrix used in testing was manufactured as follows:
Step (a) Selected dairy products, being emulsions of creams, butters and cheeses, are mixed at high shear speeds; during a high shear homogenizing stage. This stage may involve regular mixing speeds or high shear speeds between 1800 rpm to 5000 rpm, generally, but in the embodiment tested, high sheer was used prior to addition of egg whites. Step (a) is performed in a temperature range between room temperature or the lower ingredient temperature at input and 70 degrees Celsius. In this batch, 70 degrees Celsius was used.
Step (b) The appropriate amount of salts and edible acids are then added and mixing continued, to adjust the pH to a level between 2.8 and 5.5.
Step (c) The homogenized mixture from Step (b) is reformed into a stabilizing matrix by adding the gums and starches and mixed using high shear speeds. This step is performed in a temperature range between room temperature or the lower ingredient temperature at input and 70 degrees Celsius. In this batch, 70 degrees Celsius was used.
Step (d) Egg whites are added to the stabilizing matrix and the composition mixed at speeds below 1800 rpm. This step is preferably performed at a higher temperature, between 50 degrees and 80 degrees Celsius, which may denature the egg whites, activate the starches and/or improve mixing. In this batch, 80 degrees Celsius was used. For the particle size testing, additional proteins were not added.
Step (e) Optionally, during any mixing stages, or at the fill and packaging stage, it may be desirable to impose an Argon, Nitrogen or other inert gas blanket to either further reduce oxygen content and/or to inhibit the proliferation of or yeasts or molds. In this batch, inert gas blanketing was not used.
Step (f) Optionally, either during of after Step (d), larger food particles, such as sandwich proteins (meats, seafoods, cooked eggs), can be added and mixed slowly (20-50 rpms), optionally under a nitrogen or argon blanket. The process allows the emulsion to encapsulate the irregular surface of the larger food particles and force out excess gasses such as oxygen which can lead to product degradation.

The testing discussed below has demonstrated stability for freeze thaw cycles to −85 degrees Celsius with a shelf life of at least 56 days at 4 degrees Celsius. The cumulative volume of particles sizes within the matrix are shown to have a predominantly log-normal distribution centred on approximately 7.7 microns, with 95% of the particles of that size between 2 microns and 40 microns; with 94% of the particles by number being below 6 microns.

### Testing

Preliminary physical and microbiological tests demonstrate that the emulsion of the present invention used to protect seafood in a dip has a refrigeration temperature shelf-life of at least 56 days.

Testing of the emulsion of the present invention was conducted at the PEI Food Technology Centre, now referred to as Bio/Food/Tech, in Charlottetown, PEI, Canada. The goal was to compare the effect of high shear emulsification to regular mixing on quality and stability of the products. This testing involved monitoring the changes of product qualities by physical and microbiological tests during 56 days storage at refrigeration temperature, as well as a rapid thaw cycle microbiological test.

A sample of the emulsification matrix was prepared according to the following specifications and tested on the foods indicated in the tables below.

### EXAMPLE 1

TABLE 1
Ingredients List:
Items

Dairy fats, including sour cream, cream cheese,
cream, processed cheese, and Butter
Egg Whites
Meats, Poultry, Seafood
Water
Soy Oil
Lemon conc.
Vinegar
Salt
Sugar
Starch (Colflo 67)
Xanthan gum
Potassium sorbate
Citric acid
Spices to taste

### Freeze-Thaw Test

A Freeze-thaw test of the high shear emulsion was used to compare differential high shear speeds and types of starch. Four 200 g batches using the food product of Sample 3 with two starch samples from National Starch (Colflo 67™ & Frigex W™) were made following the process noted above and a third batch with no cilantro, red pepper (fresh), seafood and egg white. Two shear mixing speeds were tested: 1800 rpm and 3600 rpm. Samples were used for a freeze-thaw cycle test. About 30 ml of sample was put into a 50 ml plastic container, covered with a cap, and put in a −18° C. freezer. After 24 hours, samples were taken out of the freezer and set on the counter-top (room temperature) to thaw. Visual observation was done for any change on the composition.

Then, six samples made with 2 mixing speeds (regular mixing and high speed 3600 rpm) for each of the three products with seafood and six samples without seafood and egg white. Samples with regular mixing speed were hand stirred. Samples were put in a −18° C. freezer overnight then put in a −85° C. freezer for 1 hour, thawed at room temp and visual observation done to determine any change.

There was no visible difference between Colflo 67™ and Frigex WT™. Samples made at 1800 rpm had slight water phase separation. Based on these observations, Colflo 67™ was selected for further testing at a mixing speed of 3600 rpm for the high shear mixing steps.

As between the samples of a composition of the same ingredients created by regular mixing and high shear mixing, the samples without seafood & egg white were thinner than the samples with seafood & egg white and exuded more water after a freeze-thaw cycle. For samples with seafood & egg white, the high shear mixed samples were thicker than the regular mixed samples. Both regular speed mixed and high shear mixed samples were stable for the freeze-thaw test.

### Microbiological Stability Studies

A microbiological stability study was also performed on foods prepared using the present invention. Three 2000 g batches of each of 3 sample food products were produced and a portion of each batch was packaged to fill 16 100 g PETE bottles with lids. There were 16×100 g bottles in each batch. Three types of tests were carried out for the microbial stability study.

The first test was an accelerated thaw carried out at 36° C. At 0, 7, 24 and 30 hour TAPC was tested. Table 2 shows the outcome of the second test confirming microbiological stability of the compositions of the present invention.

TABLE 2
TAPC (CFU/g) for samples stored at 36° C. for 30 hours

| Time, hours | Sample 1 | Sample 2 | Sample 3 |
|---|---|---|---|
| 0 | 6.0 × 10′ | 6.0 × 10′ | 7.5 × 10′ |
| 7 | 8.5 × 10′ | 4.5 × 10′ | 1.9 × 10² |
| 24 | 2.0 × 10′ | 7.5 × 10′ | 1.6 × 10² |
| 30 | 6.5 × 10′ | 4.0 × 10′ | 1.0 × 10² |

The second test was exposure test by opening packages and then closing them again, and storing the samples at 4° C. for 65 hours. At 0, 24, 48 & 65 hour TAPC was tested. Three readings of pH measurement for each sample were taken at all sampling times using an Orion 3 Star Benchtop pH Meter (Thermo Electron Corporation, Beverly, Mass.).

TABLE 3
TAPC (CFU/) for samples opened & closed then stored at 4° C. for
65 hours

| Time, hours | Sample 1 | Sample 2 | Sample 3 |
|---|---|---|---|
| 0 | 2.5 × 10′ | 3.4 × 10² | 8.5 × 10¹ |
| 24 | 5.0 × 10′ | 3.5 × 10′ | 8.5 × 10¹ |
| 48 | 1.0 × 10¹ | 4.0 × 10¹ | 9.0 × 10¹ |
| 65 | 6.0 × 10′ | 1.5 × 10′ | 1.3 × 10² |

The third test involved weekly examination of each batch stored for 8 weeks at 4° C. At week 0 Total Aerobic Plate Count (TAPC), Listeria, B. cereus, & Staph were tested. At weeks 1 to 7 TAPC only was tested. At week 8 TAPC, Psychrotroph, B. cereus, & Staph were tested. Table 4 shows the outcomes of the third test, confirming microbiological stability of the compositions of the present invention.

TABLE 4
Microbiological test results for samples stored at 4° C. for 8 weeks

| Time, weeks | Microbial test | Sample 1 | Sample 2 | Sample 3 |
|---|---|---|---|---|
| 0 | TAPC | 6.0 × 10′ | 6.0 × 10′ | 7.5 × 10′ |
| | B. cereus | <5.0 | <5.0 | <5.0 |
| | S. aureus | <10 | <10 | <10 |
| | Psychrotrophs | <5.0 | <5.0 | <5.0 |
| | L. | Not Detected | Not Detected | Not Detected |
| 1 | TAPC | 3.0 × 10¹ | 2.0 × 10′ | 5.5 × 10′ |
| 2 | TAPC | 3.0 × 10¹ | 4.0 × 10′ | 7.0 × 10′ |
| 3 | TAPC | 2.5 × 10′ | 3.0 × 10¹ | 8.0 × 10¹ |
| 4 | TAPC | 5.5 × 10′ | 4.0 × 10¹ | 7.0 × 10′ |
| 5 | TAPC | 3.0 × 10′ | 9.0 × 10′ | 8.5 × 10′ |
| 6 | TAPC | 1.2 × 10² | 1.5 × 10² | 3.7 × 10² |
| 7 | TAPC | 3.0 × 10′ | 1.5 × 10′ | 1.2 × 10² |
| | TAPC | 2.0 × 10¹ | 4.5 × 10′ | 1.1 × 10² |
| | B. cereus | <5.0 | <5.0 | <5.0 |
| | S. aureus | <10 | <10 | <10 |
| | Psychrotrophs | <5.0 | <5.0 | 5 |

During 8 weeks storage at 4° C., samples of the three products with the original client formulae made with high shear mixing were satisfactory for Microbial tests.

Further continued testing of the batches demonstrated that as a preservative, the shelf-life of encapsulated seafood products in the test batch samples actually outlasted 96 days.

The composition described herein, while being comprised of an emulsion of dairy products, shows longer shelf-life than its constituent dairy product elements which have not undergone the process, and the seafood also does not spoil as quickly when coated by or embedded in the emulsification matrix.

### EXAMPLE 2

In a slightly different formulation within the scope of the processes set forth herein, a smaller sample (176 gram (10 oz)) of an emulsification matrix of the form described herein was manufactured using the following ingredients and ratios: 50 g (1.75 oz) sour cream, 22 g (0.75) oz cream cheese (Philadelphia™ brand), 42 g (1.5 oz) cream (18%), 28 g (1.0 oz) water, 14 g (0.5 oz) soy oil, 14 g (0.5 oz) egg whites, 1.55 g sea salt, 1.75 g sugar, 1.7 g vinegar, 0.6 g starch (Colflo 67™ brand), 0.2 g Xanthan gum, 0.075% w/w (0.45 g) potassium sorbate, 0.2 g citric acid.

In a first mixing step, the sour cream, cream cheese, cream, water and soy oil were shear blended at a mixing speed of 1800 rpm to 5000 rpm at a temperature of approximately 70 degrees Celsius for up to 5 minutes until liquefied. In a second mixing step, the sea salt, sugar, vinegar, potassium sorbate and citric acid were then added and shear blended at a mixing speed of 1800 rpm to 5000 rpm at a temperature of approximately 65 degrees Celsius for approximately 5 to 7 minutes. In a third mixing step, the starch and xanthan gum were then added and shear blended at a mixing speed of 1800 rpm to 5000 rpm at a temperature of approximately 65 degrees Celsius for approximately 7 to 12 minutes. In a fourth mixing step, the egg white materials were added and blended, without shearing, at a temperature of approximately 80 degrees Celsius for approximately 12 to 16 minutes. The product was then cooled to below 4 degrees Celsius for testing.

The base mixture would then have been suitable for mixing with a protein for use in a pre-packaged food such as a dip or sandwich spread. Instead, a portion was used for micelle particle size testing and another portion was subject to visual inspection under a microscope to confirm.

### Micelle Size Quantification Studies

FIG. 1 shows the graphical result of particle size distribution analysis both as a percentage of overall volume (left axis and bimodal curve) and cumulative percentage of particles above a given particle size (right axis and decreasing curve). Activation Laboratories Ltd. of Ancaster, Ontario, Canada performed the analysis according to the methods suggested in “Development of low-fat mayonnaise containing polysaccharide gums as functional ingredients”, J Sci Food Agric (2010), H. Su, C. Lien, T. Lee and R. Ho, available online at www.intersceince.wiley.com. In order to prepare a suspension or representative micelle sizes for analysis, a 1.4 gram sample of the composition was vortexed with 1.4 mg sodium dodecyl sulphate and 15 ml of commercial corn oil for 10 minutes, diluted 1:3 with corn oil and vortexed at 3290 rpm for 10 minutes, and then allowed to settle. The resulting suspension was analyzed using a Mastersizer™ 2000 in which instrument conditions were set to refractive indices for sample and dispersant (1.34 and 1.47 respectively), obscuration 5-20% (though lower dispersion was used as needed). With the settled particles excluded from the sample, 94% of the particles were in the 6 micron class. As shown in FIG. 1, the volumes of the particle sizes take a log-normal distribution about 7 microns, subject to the higher band of slightly larger particles at 100 microns 500 microns. As the sample has a crumbly, whipped cream cheese like consistency, it is suspected that the test method was unable to fully disassociate the entire sample into constituent parts, and that in production, the micelle size prior to addition of egg whites is predominantly on the order of 2 microns to 5 microns, with the less frequently larger particles being disproportionately represented in volume. FIG. 1 is largely a graphical representation of table 5 below.

TABLE 5
Micelle Sizes for composition using Mastersizer ™ 2000

| Particle Size | Percentage |
|---|---|
| (microns μm) | Volume Above |
| 0.020 | 100.00% |
| 0.030 | 100.00% |
| 0.060 | 100.00% |
| 0.120 | 100.00% |
| 0.240 | 100.00% |
| 0.490 | 100.00% |
| 0.960 | 99.92% |
| 1.960 | 98.15% |
| 3.910 | 83.32% |
| 5.520 | 67.68% |
| 7.810 | 49.18% |
| 11.050 | 32.51% |
| 15.630 | 20.65% |
| 22.100 | 13.52% |
| 31.250 | 9.51% |
| 44.190 | 7.18% |
| 62.500 | 6.08% |
| 88.390 | 6.02%\hat{ } |
| 125.000 | 5.99% |
| 176.780 | 5.31% |
| 250.000 | 3.76% |
| 353.550 | 1.68% |
| 500.000 | 0.02% |
| 707.110 | 0.00% |
| 1000.000 | 0.00% |
| 1414.210 | 0.00% |
| 2000.000 | 0.00% |

### Micelle Size Visual Verification Studies

FIG. 2 shows a magnified view of the composition of the base emulsification matrix without protein at 20× optical and 350× overall magnification next to a scale representation in which 0.1 mm represents approximately 10 microns. The sample had a soft, cream cheese consistency and was smeared on a microscope slide as evenly and smoothly as the consistency would allow. The image shown was adjusted to increase contrast, decrease intensity and rendered in greyscale to better show individual micelles. Darkened masses in the edges of the image result from the relative thickness of the composition at that position on the slide. Visual inspection of the image confirms that the micelle size is predominantly in the 2 to 5 micron range by count, such that larger particle sizes account for volume, and confirms the particle size analysis above

The illustrated embodiments are only examples of the present invention and, therefore, are non-limiting. It is to be understood that many changes in the particular structure, materials and features of the invention may be made without departing from the scope of invention as expressed in the claims and described herein.

1. An edible emulsion comprising:
(a) oil;
(b) water;
(c) fats;
(d) starches;
(e) xanthan gum;
(f) egg whites; and
(g) edible acids wherein
the oil and fats in the emulsion have micelles sizes predominantly between 1 to 40 microns:
wherein the fats are dairy fats provided from dairy products for the group of dairy products consisting of: cheese, cream cheese, sour cream, cream, butter, yogurt, milk, curds and whey.

2. The edible emulsion of claim 1 wherein the oil and fats in the emulsion have been homogenized at high shear with water during a mixing step with the xanthan gum and starches, prior to the addition of egg white solids.

3. The edible emulsion of claim 3 wherein the oil and fat in the emulsion have micelles sizes predominantly less than 6 microns.

4. The edible emulsion of claim 3 wherein the egg white solids are mixed into the emulsion at a temperature greater than 80 degrees Celsius.

5. The edible emulsion of claim 1 wherein processing of the emulsion occurs in a substantially oxygen-free atmosphere created using an inert gas blanket of nitrogen and/or argon.

6. The edible emulsion of claim 1 used for the purposes of a shelf-life extending coating for edible protein.

7. A method of manufacturing an edible emulsion comprising:
(a) A homogenizing step of homogenizing oil, water and fat to create a homogenized emulsion;
(b) Adjusting acidity during a first mixing step to an acidity of between 2.8 and 5.5, by adding an acidifying compound; and
(c) A second mixing step of adding starch and gum to the homogenized and acidified emulsion and mixing at shear speeds in excess of 1800 rpm to create a stabilization matrix; and
(d) A texture fixing step of adding an egg white containing composition to the stabilization matrix and mixing at an ambient texture fixing step temperature of between 50 degrees Celsius and 100 degrees Celsius.

8. The method of claim 7 wherein the fats are dairy fats provided from dairy products for the group of dairy products consisting of: cheese, cream cheese, sour cream, cream, butter, yogurt, milk, curds and whey.

9. The method of claim 8 wherein the homogenizing step and the first mixing step uses shear speeds in excess of 1800 rpm and less than 5000 rpm at a temperature between 4 degrees Celsius and 80 degrees Celsius.

10. The method of claim 8 wherein the second mixing step uses shear speeds in excess of 3000 rpm and less than 5000 rpm.

11. The method of claim 9 wherein the second mixing step is performed at 70 degrees Celsius and the texture fixing step is performed at 80 degrees Celsius.

12. The method of claim 11 wherein the second mixing step is continued until micelle size of the oil and fat particles in the stabilization matrix is predominantly between 1 microns and 40 microns

13. The method of claim 11 wherein the second mixing step is continued until micelle size of the oil and fat particles in the stabilization matrix is predominantly between 2 microns and 6 microns by particle count and has a log-normal distribution about 7 microns by volume.

14. The method of claim 7 wherein the acidifying compound is selected from the group of edible acids, acidifying salts or fatty acid esters consisting of: acetic acid (vinegar), ascorbic acid (vitamin C), citric acid (lemon juice), and the edible salts and fatty acid esters thereof.

15. A method of extending shelf-life of food comprising:
(a) placing the food and an edible emulsion into a mixing apparatus;
(b) Mixing the food and the edible emulsion at slow to moderate speed to coat the food without damage;
(c) wherein the edible emulsion consists of a homogenized mixture of oil, water and dairy products having an average micelle size of between 1 micron and 40 microns, mixed into a stabalization matrix further comprising xanthan gum, starch potassium sorbate and edible acids to an overall pH of between 2.8 and 5.5, and egg whites.

16. The method of claim 15 wherein the average micelle size is predominantly between 2 microns and 5 microns.

17. An edible shelf-life extending oil and water emulsion comprising:
(a) oil;
(b) Water;
(c) fats;
(d) starches;
(e) xanthan gum; and
(f) egg whites; wherein
(g) the oil, water and fats are homogenized with the xanthan gum and starches at high shear to create micelles of the oils and fats predominantly between 2 microns and 40 microns; and wherein
(h) the egg white solids are mixed into the mixture of oil, water, fats, starches and Xanthan gum at a temperature greater than 50 degrees Celsius;
(i) the processing of the emulsion occurs in a substantially oxygen-free atmosphere created using an inert gas blanket of nitrogen and/or argon; and
(j) edible proteins coated with the emulsion may be stored at 4 degrees Celsius for at least 56 days.
